(19) United States
(12) Patent Application Publication
(10) Pub. No.: US 2002/0137013 A1
(43) Pub. Date: Sep. 26, 2002

(54) Self-contained, voice activated, interactive, verbal articulate toy figure for teaching a child a chosen second language

(76) Inventor: Etta D. Nichols, Jersey City, NJ (US)

Correspondence Address: Etta D. Nichols, 28 College St., Jersey City, NJ, 07305, US

(21) Appl. No.: 10/058,244

(22) Filed: Jan. 29, 2002

Related U.S. Application Data
(60) Provisional application No. 60/261,433, filed on Jan. 16, 2001.

(51) Int. Cl. G09B 19/06

(52) U.S. Cl. 434/157

(57) ABSTRACT

A toy figure teaches a child a second language and includes a doll. A software disk containing software relating to the second language is insertable into the doll. A microphone receives human speech of the child. A speech detector detects the human speech, and in response thereto, generates a first signal representative of the human speech. A translation chip cooperates with the software disk, receives the first signal, and in response thereto, generates a second signal representative of a corresponding word of the second language. A speech generator receives the second signal, and in response thereto, generates a third audible-capable signal representative of the corresponding word of the second language. A speaker receives the third signal, and in response thereto, audiblizes the corresponding word of the second language so as to allow the child to learn to speak the second language.

### BACKGROUND OF THE INVENTION

1. Field of the Invention

The present invention relates to a self-contained, voice activated, interactive, verbal articulate toy figure. More particularly, the present invention relates to a self-contained, voice activated, interactive, verbal articulate toy figure for teaching a child a chosen second language.

2. Description of the Prior Art

Numerous innovations for interactive toy figures have been provided in the prior art that will be described. Even though these innovations may be suitable for the specific individual purposes to which they address, however, they differ from the present invention in that they do not teach a self-contained, voice activated, interactive, verbal articulate toy figure for teaching a child a chosen second language.

FOR EXAMPLE, U.S. Pat. No. 5,281,143 to Arad et al. teaches a doll, apparently capable of learning through a combination of human speech and touch interaction, that includes a speech generator for generating upon actuation the currently indexed sound in a predetermined sequence of sounds. The sequence of sounds evidences a stepwise learning process defined by a plurality of learning steps, each step being composed in turn of a predetermined subsequence of wrong sounds followed by correct sounds. A speech detector detects human speech when energized and, in response thereto, indexes the subsequence of sounds to the next sound within the current step and actuates the speech generator and, at the end of each step, indexes the sequence of sounds to the first sound of the next step and causes the speech generator to request the selected touch. A touch detector detects a selected touch when energized and, in response thereto, actuates the speech generator. The speech generator is responsive to each appropriate actuation of the speech and touch detectors for promptly generating the currently indexed sound after deactuation of the speech and touch detectors.

ANOTHER EXAMPLE, U.S. Pat. No. 5,746,602 to Kikinis teaches an interactive system for teaching, entertaining, and habituating a child that utilizes an interactive entity such as a doll, the doll having a microphone, a speaker, and control circuitry adapted for driving the speaker and microphone and a bidirectional communication link to a personal computer (PC). Scripted data stored at the computer directs doll activity and verbal articulation, and utilizes response from the child through the doll to the PC in directing output to the doll. In alternative embodiments the interactive doll has also servo-mechanisms for providing doll motion, such as eye and mouth and limb movement, which may be coordinated with verbalization in different scripts by commands retrieved at the computer and sent to the doll. In a preferred embodiment environments and applications are provided on CD-ROM disks which may also provide the operating application for the interactive doll system. Systems may be adapted for a broad range of functionality, such as acquaintance of a child with foreign languages, story telling, indirect interaction between an adult and a child through the medium of the doll, and much more.

STILL ANOTHER EXAMPLE, U.S. Pat. No. 5,807,112 to Zeck teaches a doll having body features and garb indicative of a selected food product. A storage compartment, e.g., as a pouch, is incorporated into the doll's clothing so as to contain a booklet containing nutritional information about the food product. The booklet is in the form of the food product and may contain either printed information about the food product or prerecorded information on a speech module assembly which is attached to the booklet. A tether is attached at one end to the doll and extends into the pouch with the booklet releasably attached to a second end of the tether. The tether allows the booklet to be positioned within the pouch and displaced therefrom without separation of the booklet from the doll.

YET ANOTHER EXAMPLE, U.S. Pat. No. 5,816,821 to Ouellette et al. teaches a series of bilingual educational dolls that aid in teaching children additional languages. Each doll has characteristics and costume depicting a specific recognizable Nation and each Nation is represented by both male and female figures. Provided with each doll is an accessory containing an interactive sound transmitting and recording device. Pre-recorded music with educational song lyrics are synchronized with the recording mechanism and are sung in the American English language then immediately repeated in a second language corresponding to the Nation being depicted by the characteristics and costume of doll.

STILL YET ANOTHER EXAMPLE, U.S. Pat. No. 6,022,273 to Gabai et al. teaches apparatus for a wireless computer controlled toy system including a computer system operative to transmit a first transmission via a first wireless transmitter and at least one toy including a first wireless receiver, the toy receiving the first transmission via the first wireless receiver and operative to carry out at least one action based on said first transmission. A method for controlling the toy system is also disclosed.

YET STILL ANOTHER EXAMPLE, U.S. Pat. No. 6,264,523 to Simmons teaches a communication system that includes a talking doll arranged to speak to a user and to request the user to carry out various tasks. The user responds to such requests by selecting and pressing keys on a remote keyboard. The doll and the keyboard communicate using infrared signaling. The system is programmed so that the doll can respond to the user's selection and to say whether the selection is correct or not.

STILL YET ANOTHER EXAMPLE, U.S. Pat. No. 6,290,566 to Gabai et al. teaches a toy with developing skills including a fanciful figure having a capacity to perform an action, and action control circuitry operative to control the fanciful figure to perform the action at different levels of skill at different times.

YET STILL ANOTHER EXAMPLE, U.S. Pat. No. 6,309,275 to Fong et al. teaches a set of interactive toys that perform a sequence of actions in response to one another without external activation other than an initial actuation to begin the sequence of actions. Preferably, each toy has an activation switch and/or a receiver for a wireless signal such as an infrared signal which activates the toy. Upon activation, the toy performs a desired action, such as the enunciation of a speech pattern, and signals another toy to perform a responsive action. Preferably, the toy are capable of performing several different action sequences, such as the enunciation of different conversations, the performance of different A movements, etc. Additionally, the toys are programmable by a remote control device. The remote control device either functions as an activation switch, initiating a random or predetermined (yet not user determined) sequence of interactions, or as an interaction selector, such that a desired sequence of actions may be selected.

It is apparent that numerous innovations for interactive toy figures have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a self-contained, voice activated, interactive, verbal articulate toy figure for teaching a child a chosen second language that avoids the disadvantages of the prior art.

ANOTHER OBJECT of the present invention is to provide a self-contained, voice activated, interactive, verbal articulate toy figure for teaching a child a chosen second language that is simple to use.

BRIEFLY STATED, STILL ANOTHER OBJECT of the present invention is to provide a toy figure teaches a child a second language and includes a doll. A software disk containing software relating to the second language is insertable into the doll. A microphone receives human speech of the child. A speech detector detects the human speech, and in response thereto, generates a first signal representative of the human speech. A translation chip cooperates with the software disk, receives the first signal, and in response thereto, generates a second signal representative of a corresponding word of the second language. A speech generator receives the second signal, and in response thereto, generates a third audible-capable signal representative of the corresponding word of the second language. A speaker receives the third signal, and in response thereto, audiblizes the corresponding word of the second language so as to allow the child to learn to speak the second language.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The sole FIGURE of the drawing is a diagrammatic view of the present invention.

### LIST OF REFERENCE NUMERALS UTILIZED IN THE DRAWING

10 self-contained, voice activated, interactive, verbal articulate toy figure of present invention for teaching child chosen second language

12 doll

13 interchangeable clothing of doll 12

14 slot in doll 12

16 passport of doll 12 representative of country speaking chosen second language

18 at least one selectable software disk

20 microphone for receiving human speech of child

22 speech detector for detecting human speech of child

24 translation chip

26 speech generator

28 speaker

30 control circuitry

### DETAILED DESCRIPTION OF THE PREFERRED EMBODIMENT

Referring now to the sole figure, which is a diagrammatic view of the present invention., the self-contained, voice activated, interactive, verbal articulate toy figure of the present invention is shown generally at 10 for teaching a child a chosen second language, for example French, Spanish, German, Japanese, etc.

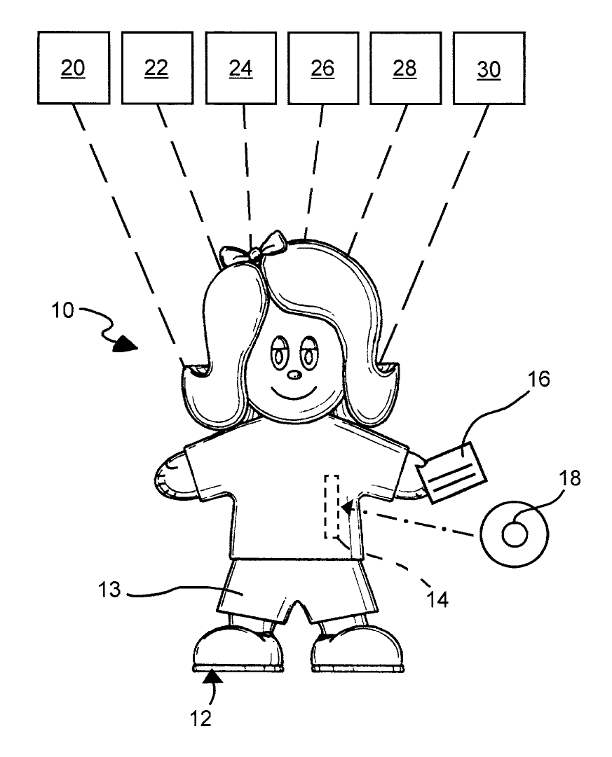

The self-contained, voice activated, interactive, verbal articulate toy figure 10 comprises a doll 12. The doll 12 is made of soft plastic and has a slot 14 therein.

The doll 12 replicates a child of approximately 4 to 5 years old and displays details depicting an ethnic background based on the chosen second language by use of at least varied skin hues and hair textures, for example for, African American, Indian, Latino, etc., and being dressed in interchangeable clothing 13 to match a country's national dress that is representative of the chosen second language, for example Spanish, French, Italian, etc., so as to allow the doll 12 to have characteristics and clothing depicting a specific recognizable nation. The doll 12 carries a passport 16 representative of a country that speaks the chosen second language.

The self-contained, voice activated, interactive, verbal articulate toy FIG. 10 further comprises at least one selectable software disk 18. The at least one selectable software disk 18 is insertable into the slot 14 in the doll 12 and contains software relating to the chosen second language.

A first selectable software disk 18 allows the self-contained, voice activated, interactive, verbal articulate toy FIG. 10 to repeat back a single word in the chosen second language that the child says to the self-contained, voice activated, interactive, verbal articulate toy FIG. 10 in English. For example, if the chosen second language is Spanish.

| ENGLISH | SPANISH |
|---|---|
| Day | Dia |
| Hello | Hola |
| Goodbye | Adios |
| Good morning | Buenos Dias |
| Good night | Buenos Noches |
| One | Uno |
| Two | Dos |
| Three | Tres |

A second selectable software disk 18 allows the self-contained, voice activated, interactive, verbal articulate toy FIG. 10 to repeat back pre-programmed phrases, based on words learned from the first selectable software disk 18, in the chosen second language that the child says to the self-contained, voice activated, interactive, verbal articulate toy FIG. 10 in English. For example, if the chosen second language is Spanish:

| ENGLISH | SPANISH |
|---|---|
| How are you? | Como estas? |
| What is your name? | Como te llama? |
| I'm hungry | Tengo Hombre |
| I don't understand | Yo no Comprendo |
| See you tomorrow | Hasta manana |

A third selectable software disk 18 allows the child to engage in an interactive conversation with the self-contained, voice activated, interactive, verbal articulate toy FIG. 10, based on the phrases learned from the second selectable software disk 18.

The first, second, and third selectable software disks 18 allow the child to change the chosen second language itself and to change incremental stages of learning of the chosen second language, both without having to purchase additional self-contained, voice activated, interactive, verbal articulate toy FIG. 10, while the interchangeable clothing 13 of the doll 12 allows the child to dress the doll 12 to match the chosen second language as the chosen second language is changed.

The self-contained, voice activated, interactive, verbal articulate toy FIG. 10 further comprises a microphone 20. The microphone 20 is contained within, and is audible through, the doll 12 and is for receiving human speech of the child.

The self-contained, voice activated, interactive, verbal articulate toy FIG. 10 further comprises a speech detector 22. The speech detector 22 is contained within the doll 12, is operatively connected to the microphone 20, is for detecting the human speech of the child, and in response thereto, generates a signal representative of the human speech of the child.

The self-contained, voice activated, interactive, verbal articulate toy FIG. 10 further comprises a translation chip 24. The translation chip 24 is contained within the doll 12, is operatively connected to the speech detector 22, cooperates with the at least one selectable software disk 18, receives the signal representative of the human speech of the child from the speech detector 22, and in response thereto, generates a signal representative of a corresponding word of the chosen second language.

The self-contained, voice activated, interactive, verbal articulate toy FIG. 10 further comprises a speech generator 26. The speech generator 26 is contained within the doll 12, is operatively connected to the translation chip 24, receives the signal representative of the corresponding word of the chosen second language from the translation chip 24, and in response thereto, generates an audible-capable signal representative of the corresponding word of the chosen second language.

The self-contained, voice activated, interactive, verbal articulate toy FIG. 10 further comprises a speaker 28. The speaker 28 is contained within, and is audible through, the doll 12, is operatively connected to the speech generator 26, receives the audible-capable signal representative of the corresponding word of the chosen second language from the speech generator 26, and in response thereto, audiblizes the corresponding word of the chosen second language, regardless of what language the human speech of the child is in, so as to form an audible word that is for hearing by the child so as to allow the child to learn to speak the chosen second language and become bilingual while playing with the self-contained, voice activated, interactive, verbal articulate toy FIG. 10 during hours of play time, and as a result thereof, the child finds it easy, entertaining, enjoyable, and fun to learn the chosen second language and a culture related thereto.

The self-contained, voice activated, interactive, verbal articulate toy FIG. 10 further comprises control circuitry 30. The control circuitry 30 is contained within the doll 12 and controls the at least one selectable software disk 18, the microphone 20, the speech detector 22, the translation chip 24, the speech generator 26, and the speaker 28, so as to direct verbal articulation of the self-contained, voice activated, interactive, verbal articulate toy FIG. 10.

It will be understood that each of the elements described above, or two or more together, may also find a useful application in other types of constructions differing from the types described above.

While the invention has been illustrated and described as embodied in a self-contained, voice activated, interactive toy figure for teaching a child a chosen second language, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A self-contained, voice activated, interactive, verbal articulate toy figure for teaching a child a chosen second language, said figure comprising:
a) a doll;
b) at least one selectable software disk;
c) a microphone;
d) a speech detector;
e) a translation chip;
f) a speech generator; and
g) a speaker;
wherein said at least one selectable software disk is insertable into said doll;
wherein said at least one selectable software disk contains software relating to the chosen second language;
wherein said microphone is contained within said doll;
wherein said microphone is audible through said doll;
wherein said microphone is for receiving human speech of the child;
wherein said speech detector is contained within said doll;
wherein said speech detector is operatively connected to said microphone;
wherein said speech detector is for detecting the human speech of the child, and in response thereto, generates a signal representative of the human speech of the child;
wherein said translation chip is contained within said doll;
wherein said translation chip is operatively connected to said speech detector;
wherein said translation chip cooperates with said at least one selectable software disk;
wherein said translation chip receives said signal representative of the human speech of the child from said speech detector, and in response thereto, generates a signal representative of a corresponding word of the chosen second language;
wherein said speech generator is contained within said doll;
wherein said speech generator is operatively connected to said translation chip;
wherein said speech generator receives said signal representative of the corresponding word of the chosen second language from said translation chip, and in response thereto, generates an audible-capable signal representative of the corresponding word of the chosen second language;
wherein said speaker is contained within said doll;
wherein said speaker is audible through said doll;
wherein said speaker is operatively connected to said speech generator; and
wherein said speaker receives said audible-capable signal representative of the corresponding word of the chosen second language from said speech generator, and in response thereto, audiblizes the corresponding word of the chosen second language, regardless of what language the human speech of the child is in, so as to form an audible word that is for hearing by the child so as to allow the child to learn to speak the chosen second language and become bilingual while playing with said self-contained, voice activated, interactive, verbal articulate toy figure during hours of play time, and as a result thereof, the child finds it easy, entertaining, enjoyable, and fun to learn the chosen second language and a culture related thereto.

2. The figure as defined in claim 1; further comprising control circuitry;
wherein said control circuitry is contained within said doll; and
wherein said control circuitry controls said at least one selectable software disk, said microphone, said speech detector, said translation chip, said speech generator, and said speaker, so as to direct verbal articulation of said self-contained, voice activated, interactive, verbal articulate toy figure.

3. The figure as defined in claim 1, wherein said doll is made of soft plastic.

4. The figure as defined in claim 1, wherein said doll replicates a child of approximately 4 to 5 years old; and
wherein said doll displays details depicting an ethnic background based on the chosen second language by use of at least varied skin hues and hair textures and being dressed in interchangeable clothing to match a country's national dress that is representative of the chosen second language so as to allow said doll to have characteristics and clothing depicting a specific recognizable nation.

5. The figure as defined in claim 1, wherein said doll carries a passport; and
wherein said passport is representative of a country that speaks the chosen second language.

6. The figure as defined in claim 1, wherein said doll has a slot therein; and
wherein said at least one selectable software disk is insertable into said slot in said doll.

7. The figure as defined in claim 1, wherein a first selectable software disk allows said self-contained, voice activated, interactive, verbal articulate toy figure to repeat back a single word in the chosen second language that the child says to said self-contained, voice activated, interactive, verbal articulate toy figure in English.

8. The figure as defined in claim 7, wherein a second selectable software disk allows said self-contained, voice activated, interactive, verbal articulate toy figure to repeat back pre-programmed phrases, based on words learned from said first selectable software disk, in the chosen second language that the child says to said self-contained, voice activated, interactive, verbal articulate toy figure in English.

9. The figure as defined in claim 8, wherein a third selectable software disk allows the child to engage in an interactive conversation with said self-contained, voice activated, interactive, verbal articulate toy figure, based on the phrases learned from said second selectable software disk.

10. The figure as defined in claim 9, wherein said first, second, and third selectable software disks allow the child to change the chosen second language itself and to change incremental stages of learning of the chosen second language, both without having to purchase additional self-contained, voice activated, interactive, verbal articulate toy figures, while said interchangeable clothing of said doll allows said child to dress said doll to match the chosen second language as the chosen second language is changed.
